(19) United States
(12) Patent Application Publication
(10) Pub. No.: US 2012/0263993 A1
(43) Pub. Date: Oct. 18, 2012

(54) ELECTROCHEMICAL DEVICE

(75) Inventors: Akihisa Hosoe, Osaka-shi (JP); Kazuki Okuno, Osaka-shi (JP); Hajime Ota, Osaka-shi (JP); Koutarou Kimura, Osaka-shi (JP); Kengo Goto, Osaka-shi (JP); Hideaki Sakaida, Osaka-shi (JP); Junichi Nishimura, Imizu-shi (JP)

(73) Assignees: SUMITOMO ELECTRIC TOYAMA CO., LTD., Imizu-shi (JP); SUMITOMO ELECTRIC INDUSTRIES, LTD., Osaka-shi (JP)

(21) Appl. No.: 13/449,712

(22) Filed: Apr. 18, 2012

Related U.S. Application Data
(63) Continuation of application No. PCT/JP2012/053272, filed on Feb. 13, 2012.

(30) Foreign Application Priority Data
Feb. 18, 2011 (JP) 2011-032701
Jan. 11, 2012 (JP) 2012-003014

(51) Int. Cl. H01M 4/62; H01G 9/155; H01M 2/14; H01G 9/15

(52) U.S. Cl. 429/131; 361/523; 361/502; 429/232

(57) ABSTRACT

Provided is an electrochemical device which is easy to produce and which has excellent characteristics. An electrochemical device includes a first electrode including an aluminum porous body having interconnecting pores and an active material filled into the pores of the aluminum porous body, a separator, and a second electrode, the first electrode, the separator, and the second electrode being stacked, in which a plurality of electrode bodies each including the first electrode, the separator, and the second electrode are stacked without being wound.

### CROSS REFERENCES TO RELATED APPLICATIONS

This application is a Continuation of International Patent Application No. PCT/JP2012/053272, filed Feb. 13, 2012, which claims the benefit of Japanese Patent Application No. 2011-032701 filed in the Japan Patent Office on Feb. 18, 2011 and Japanese Patent Application No. 2012-003014 filed in the Japan Patent Office on Jan. 11, 2012, the entire contents of these applications being incorporated herein by reference.

### TECHNICAL FIELD

The present invention relates to an electrochemical device including an aluminum porous body, and in particular, relates to an electrode structure thereof. The term “electrochemical device” refers to a lithium battery, such as a lithium secondary battery, and to a capacitor having a nonaqueous electrolyte (hereinafter, simply referred to as a “capacitor”), a lithium ion capacitor having a nonaqueous electrolyte (hereinafter, simply referred to as a “lithium ion capacitor”), or the like.

### BACKGROUND ART

In recent years, electrochemical devices, such as lithium batteries, capacitors, and lithium ion capacitors, which are used in portable information terminals and power storage apparatuses for electric vehicle and household use, have been actively researched. An electrochemical device includes a first electrode, a second electrode, and an electrolyte. A lithium secondary battery includes a positive electrode serving as a first electrode, a negative electrode serving as a second electrode, and an electrolyte, and charging or discharging thereof is performed by transporting lithium ions between the positive electrode and the negative electrode.

Furthermore, each of a capacitor and a lithium ion capacitor includes a first electrode, a second electrode, and an electrolyte, and charging or discharging thereof is performed by adsorption/desorption of lithium ions at the first and second electrodes. In the case of the lithium ion capacitor, the first electrode corresponds to a positive electrode, and the second electrode corresponds to a negative electrode.

In general, a first electrode or a second electrode includes a current collector and a mixture. As a current collector for a positive electrode (first electrode), an aluminum foil is known to be used, and also a porous metal body composed of aluminum having three-dimensionally arranged pores is known to be used. An aluminum foam produced by foaming aluminum is known as the porous metal body composed of aluminum. For example, a method of producing an aluminum foam in which a foaming agent and a thickening agent are added to an aluminum metal in a molten state, followed by stirring is disclosed in Patent Document 1. The resulting aluminum foam has many closed cells (closed pores) attributable to the production method.

As a porous metal body, a nickel porous body having interconnecting pores and having a high porosity (90% or more) is widely known. The nickel porous body is produced by forming a nickel layer on the surface of the skeleton of a foamed resin having interconnecting pores, such as a polyurethane foam, then thermally decomposing the foamed resin, and further subjecting the nickel to reduction treatment. However, a problem has been pointed out that, when the potential of the nickel porous body, which is a positive electrode (first electrode) current collector, becomes noble in an organic electrolytic solution, the resistance to electrolytic solution of the nickel porous body becomes poor. In contrast, in the case where the material constituting a porous body is aluminum, such a problem is not caused.

Accordingly, a method of producing an aluminum porous body to which the method of producing a nickel porous body is applied has also been developed. For example, Patent Document 2 discloses such a method. That is, “a method of producing a metal porous body in which a coating film of a metal capable of forming a eutectic alloy at a temperature not higher than the melting point of Al is formed, using a plating method or a gas-phase method, such as vapor deposition, sputtering, or CVD, on a skeleton of a foamed resin having a three-dimensional network structure, then the foamed resin provided with the coating film is impregnated and coated with a paste containing Al powder, a binder, and an organic solvent as main components, and heat treatment is performed in a non-oxidizing atmosphere at a temperature of 550° C. to 750° C.” is disclosed.

### CITATION LIST

### Patent Literature

[Patent Document 1] Japanese Unexamined Patent Application Publication No. 2002-371327
[Patent Document 2] Japanese Unexamined Patent Application Publication No. 8-170126

### SUMMARY OF INVENTION

### Technical Problem

In order to increase the battery capacity, it is necessary to increase the amount of a positive electrode active material as much as possible. In an existing electrode having an aluminum foil as a current collector, it is conceivable to coat an active material with a large thickness on the surface of the foil in order to increase the amount of the active material. However, the coating thickness that can be obtained is limited to about 100 μm. Furthermore, even if an electrode having an active material with a large thickness can be formed, because of an increased distance between the active material and the current collector, many aspects of the battery performance are sacrificed.

A lithium battery has a structure in which a stacked body including a positive electrode composed of an aluminum foil coated with an active material, a separator, and a negative electrode composed of a copper foil coated with an active material is wound into a cylindrical shape, the cylindrical shape is directly used or is further flattened, and thereby the electrode area is increased. The electrode having an aluminum foil as a current collector is thin as described above, and in order to obtain a sufficient capacity, it is necessary to increase the number of turns, which results in a length of several meters. Furthermore, since the active material changes its volume in response to charging and discharging, there is a possibility that the electrode that is wound at a high density may be broken because it cannot absorb the change in volume. Instead of the wound electrode, a structure in which a plurality of flat electrodes are stacked is also conceivable. However, the number of electrodes to be stacked is very large, which is not practical in terms of production difficulties and the like.

A capacitor has a structure in which a stacked body including first and second electrodes each composed of an aluminum foil coated with an active material and a separator is wound into a cylindrical shape, the cylindrical shape is directly used or is further flattened, and thereby the electrode area is increased. The electrode having an aluminum foil as a current collector is thin as described above, and in order to obtain a sufficient capacity, it is necessary to increase the number of turns, which results in a length of several meters. Instead of the wound electrode, a structure in which a plurality of flat electrodes are stacked is also conceivable. However, the number of electrodes to be stacked is very large, which is not practical in terms of production difficulties and the like.

A lithium ion capacitor has a structure in which a stacked body including a positive electrode composed of an aluminum foil coated with an active material, a separator, and a negative electrode composed of a copper foil coated with an active material is wound into a cylindrical shape, the cylindrical shape is directly used or is further flattened, and thereby the electrode area is increased. The electrode having an aluminum foil as a current collector is thin as described above, and in order to obtain a sufficient capacity, it is necessary to increase the number of turns, which results in a length of several meters. Instead of the wound electrode, a structure in which a plurality of flat electrodes are stacked is also conceivable. However, the number of electrodes to be stacked is very large, which is not practical in terms of production difficulties and the like.

Accordingly, a design in which an aluminum porous body is used instead of the aluminum foil has been examined. However, existing aluminum porous bodies are not suitable for use as current collectors for electrodes for nonaqueous electrolyte batteries, which is a problem. That is, an aluminum foam, which is one of aluminum porous bodies, has closed pores attributable to the production method thereof, and even if the surface area is increased by foaming, not all of the surfaces can be effectively used. Regarding an aluminum porous body produced by a method to which the method of producing a nickel porous body is applied, in addition to aluminum, inclusion of a metal that forms an eutectic alloy with aluminum cannot be avoided, which is a problem.

The present invention has been achieved in view of the problems described above. It is an object of the present invention to provide an electrochemical device which is easy to produce and which has excellent characteristics by using aluminum porous bodies in electrodes for the electrochemical device and by forming and stacking thick electrodes using the aluminum porous bodies as current collectors.

### Solution to Problem

The inventors of the present application have diligently developed an aluminum structure having a three-dimensional network structure, which can be widely used for an electrochemical device, such as a lithium battery. The method of producing an aluminum structure includes imparting electrical conductivity to the surface of a sheet-like foam of polyurethane, a melamine resin, or the like, having a three-dimensional network structure; performing aluminum plating on the surface thereof; and then removing the polyurethane or melamine resin.

According to an aspect of the present invention, an electrochemical device includes a first electrode including an aluminum porous body having interconnecting pores and an active material filled into the pores of the aluminum porous body, a separator, and a second electrode, the first electrode, the separator, and the second electrode being stacked, in which a plurality of electrode bodies each including the first electrode, the separator, and the second electrode are stacked without being wound.

The first electrode, the separator, and the second electrode each may have a rectangular shape in plan view. Furthermore, the first electrode or the second electrode may be configured so as to be enclosed by the separator. The term “rectangular shape” means a shape which is substantially square (regular square or oblong).

In such a manner, by using an aluminum porous body having interconnecting pores, instead of the existing aluminum foil, as a current collector, a large amount of the active material can be retained in the porous body, and a thick electrode can be formed while maintaining a short distance between the active material and the current collector. Consequently, the electrode capacity, i.e., the surface capacity density, can be increased. Furthermore, since the thickness can be increased, a battery with the same capacity as that of an existing battery can be produced with a smaller number of stackings in the electrochemical device as a whole, the amounts of expensive separators and current collectors used for electrodes can be decreased, and the number and usage of tabs and the number of times welding is performed can be decreased, resulting in a large reduction in production costs.

Furthermore, in comparison with a structure in which a long electrode is wound, by using the stacked structure, the electrode size can be freely designed, and changes in volume of the active material both in the thickness direction and in the planar direction can be easily absorbed. The simplification in the structure permits larger freedom in structural design, and for example, various types of heat dissipation design can be employed. Furthermore, since the number of stackings is small, the electrochemical device control system, such as detection and separation of defective portions, can be simplified. In particular, by forming electrodes into a rectangular shape, i.e., a square shape, in plan view, the electrodes can be arranged at a high density. Furthermore, in such a stacked structure, when a failure occurs, by removing electrodes in defective portions only, other normal portions can be used or reused, which is also advantageous.

The first electrode is preferably compressed in the thickness direction after the active material has been filled into the pores of the aluminum porous body having interconnecting pores. In this case, while making use of the advantages described above, electrode thickness control is facilitated, thus contributing an overall reduction in thickness.

According to another aspect of the present invention, an electrochemical device includes a first electrode including an aluminum structure having an aluminum foil and a three-dimensional structure composed of aluminum disposed on a surface of the aluminum foil, and an active material filled into the three-dimensional structure of the aluminum structure; a separator; and a second electrode, the first electrode, the separator, and the second electrode being stacked, in which a plurality of electrode bodies each including the first electrode, the separator, and the second electrode are stacked without being wound.

In the electrochemical device, the three-dimensional structure composed of aluminum may be an aluminum porous body having interconnecting pores.

In this new current collector structure, while maintaining an in-plane current collecting property, the filling amount of the active material per unit volume can be increased. Furthermore, an improvement in output characteristics can be achieved by shortening the current collecting distance. That is, the volume energy density is improved and the output characteristics are improved. Furthermore, since an aluminum foil is disposed only on one surface, even when a winding structure is employed, winding can be easily performed, which is advantageous. Of course, in the case of a stack-type structure in which winding is not performed, the advantages described above can be similarly obtained.

According to another aspect of the present invention, a lithium secondary battery includes a negative electrode including an aluminum porous body having interconnecting pores and an active material filled into the pores of the aluminum porous body, a separator, and a positive electrode, the negative electrode, the separator, and the positive electrode being stacked.

Since aluminum is used as a current collector for the negative electrode, when the potential of the negative electrode becomes a certain value or less with respect to the lithium potential, aluminum becomes embrittled due to formation of an alloy with lithium, resulting in breakage. By purposely using such a structure, the current collector is broken, and the electricity stops flowing. That is, the current collector of the negative electrode functions as a safety device. Furthermore, a reduction in weight is achieved in comparison with the case where copper is used as a current collector of the negative electrode.

In the lithium secondary battery, preferably, the negative electrode does not contain carbon. By keeping the negative electrode from containing carbon, it is possible to prevent decomposition of the electrolytic solution due to carbon.

The electrochemical device of the present invention may be a lithium secondary battery, in which the first electrode is a positive electrode, and the second electrode is a negative electrode.

In the lithium secondary battery, preferably, the negative electrode does not contain carbon. By keeping the negative electrode from containing carbon, it is possible to prevent decomposition of the electrolytic solution due to carbon.

Furthermore, in existing lithium secondary batteries, for example, the temperature and voltage are controlled per cell, and an abnormally high current is prevented from flowing by using a fuse or the like. Furthermore, in some cases, a porous membrane made of resin may be used as a separator, and when heat is generated, pores are fused to block ion conduction. Furthermore, the surfaces of electrodes may be coated with a ceramic to reduce the reaction of the electrolytic solution. Such structures have problems in that outside controls per cell result in high costs, and it is difficult to guarantee theoretical safety. According to the aspect of the present invention, such problems can be solved.

The electrochemical device of the present invention may be a capacitor. By using the aluminum porous body as a current collector, the surface area of the current collector increases, and the contact area with activated carbon as the active material increases. Therefore, it is possible to obtain a capacitor capable of increasing output and capacity. Furthermore, since the thickness can be increased, a battery with the same capacity as that of an existing battery can be produced with a lower number of stackings in the capacitor as a whole, and the amounts of use of expensive separators and current collectors for electrodes can be decreased, resulting in a large reduction in production costs.

The electrochemical device of the present invention may be a lithium ion capacitor. By using the aluminum porous body as a current collector, the surface area of the current collector increases, and even if activated carbon as the active material is applied thinly, it is possible to obtain a lithium ion capacitor capable of increasing output and capacity. Furthermore, it becomes possible to control the balance in the capacity density per unit area in the positive electrode and the negative electrode, and as a result, the capacity density of the entire device can be increased.

### Advantageous Effects of Invention

According to the present invention, when aluminum porous bodies are used in electrodes for battery, by forming and stacking thick electrodes using the aluminum porous bodies as current collectors, it is possible to provide an electrochemical device which is easy to produce and which has excellent characteristics.

### BRIEF DESCRIPTION OF DRAWINGS

FIG. 1 is a flow diagram showing a production process of an aluminum structure according to the present invention.

FIGS. 2(a) to 2(d) are cross-sectional schematic views illustrating the production process of an aluminum structure according to the present invention.

FIG. 3 is a schematic view showing a structural example in which an aluminum porous body according to the present invention is used in a lithium battery.

FIG. 4 is a schematic view showing a structural example in which aluminum porous bodies according to the present invention are used in a capacitor.

FIG. 5 is a schematic view showing a structural example in which an aluminum porous body according to the present invention is used in a lithium ion capacitor.

FIG. 6 is a cross-sectional schematic view showing a structural example in which aluminum porous bodies according to the present invention are used in a molten salt battery.

FIG. 7 is an SEM photograph showing an aluminum porous body according to Example.

FIG. 8 is a cross-sectional schematic view illustrating a stacking state of electrodes in a lithium secondary battery as an example of the present invention.

FIG. 9 is a cross-sectional schematic view showing an example of an aluminum structure including a three-dimensional structure composed of aluminum disposed on the surface of an aluminum foil according to the present invention.

### DESCRIPTION OF EMBODIMENTS

The embodiments of the present invention will be described below, in which a process for producing an aluminum porous body, as a specific example of a metal porous body, will be described as a representative example, with reference to the drawings as appropriate. As the aluminum porous body, an aluminum structure having a three-dimensional network structure, which has the same skeleton structure as that of nickel Celmet (Celmet is a registered trademark), is specifically shown. In the drawings to which reference is made, the same reference numerals denote the same or corresponding portions. It is intended that the scope of the present invention is determined not by the embodiments but by appended claims, and includes all variations of the equivalent meanings and ranges to the claims.

### (Aluminum Porous Body)

### (Production Process of Aluminum Structure)

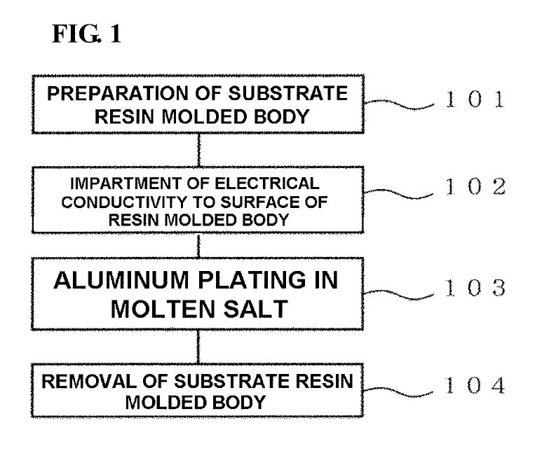

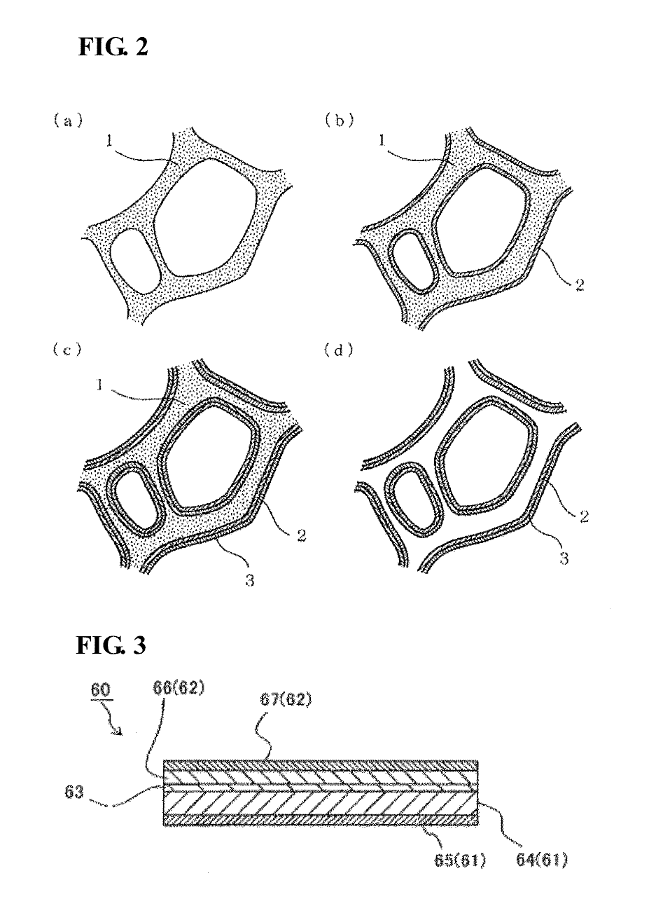

FIG. 1 is a flow diagram showing a production process of an aluminum structure. FIGS. 2(a) to 2(d) correspond to the flow diagram and schematically show how an aluminum structure is produced using a resin molded body as a core. The entire flow of the production process will be described with reference to FIG. 1 and FIGS. 2(a) to 2(d). First, preparation of a substrate resin molded body (101) is performed. FIG. 2(a) is an enlarged schematic view showing a portion of a surface of a foamed resin molded body having interconnecting pores, as an example of a substrate resin molded body. A foamed resin molded body 1 serves as a skeleton and has pores therein. Next, impartment of electrical conductivity to the surface of the resin molded body (102) is performed. Thereby, as shown in FIG. 2(b), a conductive layer 2 made of a conductive material is thinly formed on the surface of the resin molded body 1. Subsequently, aluminum plating in a molten salt (103) is performed to form an aluminum plating layer 3 on the surface of the resin molded body provided with the conductive layer (refer to FIG. 2(c)). Thus, an aluminum structure, which includes the substrate resin molded body as a substrate and the aluminum plating layer 3 formed on the surface thereof, is obtained. Then, removal of the substrate resin molded body (104) may be performed. By removing the foamed resin molded body 1 by decomposition or the like, an aluminum structure (porous body) in which the metal layer only remains can be obtained (refer to FIG. 2(d)). The individual steps will be described in order below.

### (Preparation of Porous Resin Molded Body)

A porous resin molded body having a three-dimensional network structure and having interconnecting pores is prepared. As a material for the porous resin molded body, any resin may be selected. For example, a foamed resin molded body of polyurethane, a melamine resin, polypropylene, polyethylene, or the like may be used. Although expressed as the foamed resin molded body, a resin molded body having any shape can be selected as long as it has pores connecting with each other (interconnecting pores). For example, a body having a nonwoven fabric-like shape in which resin fibers are entangled with each other can be used instead of the foamed resin molded body. Preferably, the foamed resin molded body has a porosity of 80% to 98% and a cell diameter of 50 to 500 μm. A polyurethane foam and a foamed melamine resin have a high porosity, an interconnecting property of pores, and excellent heat decomposability, and therefore can be suitably used as a foamed resin molded body. A polyurethane foam is preferable in terms of uniformity of pores, easy availability, and the like, and a foamed melamine resin is preferable from the standpoint that a foamed resin molded body having a small cell diameter can be obtained.

In many cases, the foamed resin molded body has residues, such as a foaming agent and unreacted monomers, in the foam production process, and it is preferable to carry out cleaning treatment for the subsequent steps. For example, in the case of a polyurethane foam, the resin molded body, as a skeleton, constitutes a three-dimensional network, and thus, as a whole, interconnecting pores are formed. The skeleton of the polyurethane foam has a substantially triangular shape in a cross section perpendicular to the direction in which the skeleton extends. The porosity is defined by the following formula:

Porosity=(1−(weight of porous material[g]/(volume of porous material[cm³]×material density)))×100[%]

Furthermore, the cell diameter is determined by a method in which a magnified surface of a resin molded body is obtained by a photomicroscope or the like, the number of pores per inch (25.4 mm) is calculated as the number of cells, and an average value is obtained by the formula: average cell diameter=25.4 mm/number of cells.

### (Impartment of Electrical Conductivity to Surface of Resin Molded Body)

In order to perform electrolytic plating, the surface of the porous resin is subjected to electrical conductivity-imparting treatment in advance. The treatment is not particularly limited as long as it can provide a layer having conductivity on the surface of the porous resin, and any method, such as electroless plating of a conductive metal, e.g., nickel, vapor deposition or sputtering of aluminum or the like, or application of a conductive coating material containing conductive particles of carbon or the like, may be selected. A method of imparting electrical conductivity by sputtering of aluminum and a method of imparting electrical conductivity to the surface of a porous resin using conductive particles of carbon will be described below as examples of the electrical conductivity-imparting treatment.

### Sputtering of Aluminum

Sputtering using aluminum is not particularly limited as long as aluminum is used as a target, and may be performed by an ordinary method. For example, after a porous resin is fixed on a substrate holder, by applying DC voltage between the holder and the target (aluminum) while introducing inert gas, ionized inert gas is made to collide with aluminum, and sputtered aluminum particles are deposited on the surface of the porous resin to form a sputtered film of aluminum. The sputtering may be performed under temperatures at which the porous resin is not melted, specifically, at about 100° C. to 200° C., and preferably at about 120° C. to 180° C.

### Application of Carbon

A carbon coating material as a conductive coating material is prepared. A suspension as the conductive coating material preferably contains carbon particles, a binder, a dispersant, and a dispersing medium. In order to perform application of carbon particles uniformly, the suspension needs to maintain a uniformly suspended state. Accordingly, the suspension is preferably maintained at 20° C. to 40° C. The reason for this is that, when the temperature of the suspension is lower than 20° C., the uniformly suspended state is lost, and a layer is formed such that only the binder is concentrated on the surface of the skeleton constituting the network structure of the porous resin molded body. In this case, the layer of carbon particles applied is easily peeled off, and it is difficult to form firmly adhered metal plating. On the other hand, when the temperature of the suspension exceeds 40° C., the amount of evaporation of the dispersant is large, the suspension becomes concentrated as application treatment time passes, and the carbon coating amount is likely to change. Furthermore, the particle size of carbon particles is 0.01 to 5 μm, and preferably 0.01 to 0.5 μm. When the particle size is large, the particles may clog pores of the porous resin molded body or block smooth plating. When the particle size is excessively small, it is difficult to secure sufficient conductivity.

Application of carbon particles to a porous resin molded body can be performed by immersing the target resin molded body in the suspension, followed by squeezing and drying. For example, in a practical production process, a strip-shaped resin having a three-dimensional network structure, in the form of a long sheet, is continuously drawn from a supply bobbin and immersed in the suspension in a tank. The strip-shaped resin immersed in the suspension is squeezed with squeezing rolls, and the excess suspension is squeezed out. Then, the dispersing medium and the like in the suspension are removed by subjecting the strip-shaped resin to hot air jetting with a hot air nozzle, or the like. After the strip-shaped resin is thoroughly dried, it is taken up by a take-up bobbin. The temperature of hot air may be in the range of 40° C. to 80° C. By using such an apparatus, electrical conductivity-imparting treatment can be performed automatically and continuously, and it is possible to form a skeleton having a network structure free from clogging and provided with a uniform conductive layer. Therefore, the subsequent step of metal plating can be smoothly carried out.

### (Formation of Aluminum Layer: Molten Salt Plating)

Next, electrolytic plating is performed in a molten salt to form an aluminum plating layer on the surface of the resin molded body. By performing aluminum plating in a molten salt bath, in particular, it is possible to form a uniformly thick aluminum layer on the surface of a complex skeleton structure, such as a porous resin molded body having a three-dimensional network structure. Using the resin molded body, the surface of which has been imparted with electrical conductivity, as a cathode and aluminum having a purity of 99.0% as an anode, a DC current is applied in the molten salt. As the molten salt, an organic molten salt which is a eutectic salt of an organic halide and an aluminum halide or an inorganic molten salt which is a eutectic salt of an alkali metal halide and an aluminum halide can be used. When a bath of an organic molten salt which melts at a relatively low temperature is used, the resin molded body serving as a substrate can be plated without being decomposed, which is preferable. As the organic halide, an imidazolium salt, pyridinium salt, or the like can be used. Specifically, 1-ethyl-3-methylimidazolium chloride (EMIC) and butylpyridinium chloride (BPC) are preferable. When moisture or oxygen is mixed into a molten salt, the molten salt is degraded. Therefore, preferably, plating is performed in an inert gas atmosphere, such as nitrogen or argon, and under a sealed environment.

As the molten salt bath, a nitrogen-containing molten salt bath is preferably used, and an imidazolium salt bath is particularly preferably used. In the case where a salt which melts at high temperature is used as the molten salt, dissolution into the molten salt or decomposition of the resin proceeds faster than growth of the plating layer, and it is not possible to form a plating layer on the surface of the resin molded body. The imidazolium salt bath can be used without affecting the resin even at a relatively low temperature. As the imidazolium salt, a salt containing an imidazolium cation having alkyl groups at the 1- and 3-positions is preferably used. In particular, an aluminum chloride+1-ethyl-3-methylimidazolium chloride (AlCl₃+EMIC) molten salt is most preferably used because it has high stability and is hard to decompose. Plating onto a polyurethane foam, a foamed melamine resin, or the like is possible, and the temperature of the molten salt bath is 10° C. to 65° C., and preferably 25° C. to 60° C. As the temperature decreases, the current density range in which plating can be performed narrows, and it becomes difficult to perform plating over the entire surface of the porous resin molded body. At a high temperature exceeding 65° C., a problem of deformation of the substrate resin is likely to occur.

In a molten salt aluminum plating onto a surface of metal, for the purpose of improving smoothness of the plating surface, addition of an additive, such as xylene, benzene, toluene, or 1,10-phenanthroline, to AlCl₃-EMIC has been reported. The present inventors have found that, in particular, in the case where aluminum plating is performed on a porous resin molded body having a three-dimensional network structure, addition of 1,10-phenanthroline exhibits particular effects in forming an aluminum structure. That is, a first feature is that the smoothness of the plating film is improved and the aluminum skeleton constituting the porous body is hard to break, and a second feature is that it is possible to perform uniform plating in which the difference in plating thickness between the surface portion and the interior portion of the porous body is small.

Because of the two features, i.e., the property of being hard to break and uniformity in the plating thickness inside and outside, in the case where the finished aluminum porous body is subjected to pressing or the like, the entire skeleton is hard to break and it is possible to obtain a porous body which is uniformly pressed. When aluminum porous bodies are used as an electrode material for batteries and the like, electrodes are filled with an electrode active material and the density is increased by pressing. In the active material filling process and during pressing, skeletons are likely to break. Therefore, the aluminum structure according to the embodiment is highly advantageous in such an application.

For the reason described above, it is preferable to add an organic solvent to the molten salt bath, and in particular, 1,10-phenanthroline is preferably used. The amount of the organic solvent to be added to the plating bath is preferably 0.2 to 7 g/L. At 0.2 g/L or less, the resulting plating layer has poor smoothness and is brittle, and the effect of decreasing the difference in thickness between the surface layer and the interior portion is hard to obtain. At 7 g/L or more, the plating efficiency is decreased, and it is difficult to obtain a predetermined plating thickness.

It is also possible to use an inorganic salt bath as the molten salt within a range that the resin is not dissolved or the like. The inorganic salt bath is typically an AlCl₃—XCl (X: alkali metal) binary salt system or multicomponent salt system. In such an inorganic salt bath, although the melting temperature is generally high compared with organic salt baths, such as an imidazolium salt bath, environmental conditions, such as moisture and oxygen, are less limited, and low-cost practical implementation is generally possible. In the case where the resin is a foamed melamine resin, use at a high temperature is possible compared with a polyurethane foam, and an inorganic salt bath at 60° C. to 150° C. is used.

Through the steps described above, it is possible to obtain an aluminum structure including the resin molded body as a core of the skeleton. This aluminum structure may be used as a resin-metal composite depending on the intended use, such as for various filters and catalyst carriers. When the aluminum structure is used as a metal porous body without including the resin owing to usage environment constraints or the like, the resin is removed. In the present invention, the resin is removed by decomposition in a molten salt, which will be described below, so as to prevent oxidation of aluminum.

(Removal of Resin: Treatment with Molten Salt)

Decomposition in a molten salt is performed by a method described below. The resin molded body provided with the aluminum plating layer on the surface thereof is immersed in a molten salt, and heating is performed while applying a negative potential (baser potential than the aluminum standard electrode potential) to the aluminum layer to remove the porous resin molded body. When a negative potential is applied in a state in which the structure is immersed in the molten salt, it is possible to decompose the porous resin molded body without oxidizing aluminum. The heating temperature may be appropriately selected in accordance with the type of the porous resin molded body. When the resin molded body is composed of polyurethane, decomposition occurs at about 380° C., and therefore the temperature of the molten salt bath needs to be set at 380° C. or higher. However, it is necessary to carry out treatment at a temperature of the melting point (660° C.) of aluminum or lower so as not to melt aluminum. A preferred temperature range is 500° C. to 600° C. The magnitude of the negative potential to be applied is on the negative side with respect to the reduction potential of aluminum and on the positive side with respect to the reduction potential of cations in the molten salt. By such a method, it is possible to obtain an aluminum porous body having interconnecting pores and having a thin oxide layer on the surface thereof and a low oxygen content.

The molten salt used in the decomposition of the resin may be a halide salt of an alkali metal or alkaline earth metal such that the aluminum electrode potential becomes base. Specifically, preferably, the molten salt contains one or more selected from the group consisting of lithium chloride (LiCl), potassium chloride (KCl), and sodium chloride (NaCl). By such a method, it is possible to obtain an aluminum porous body having interconnecting pores and having a thin oxide layer on the surface thereof and a low oxygen content.

### (Formation of Electrode for Battery)

A plurality of aluminum porous bodies thus obtained are stacked to form a current collector of an electrode for battery. It is preferable to stack the aluminum porous bodies after an active material has been filled into the aluminum porous bodies from the standpoint that the active material can be easily filled into the inside and that filling can be performed successively to the production of porous bodies. It may also be possible to perform filling after stacking has been performed. In this case, electrical conduction and mechanical connection between porous bodies can be easily obtained, which is advantageous. The number of porous bodies to be stacked can be arbitrarily designed depending on the desired battery capacity, and thus can be selected in accordance with ease of stacking and the structural design of the entire battery.

Furthermore, the porous bodies may be subjected to compression forming in the thickness direction of the porous body sheet after the active material has been filled into the porous bodies or the porous bodies have been stacked. Thereby, the filling density can be increased, and since the distance between the active material and the current collector is shortened, battery performance can be improved.

### (Lithium Battery (Including Lithium Secondary Battery, Lithium Ion Secondary Battery, or the Like))

Electrode materials for batteries including aluminum porous bodies and batteries will be described below. For example, in the case where an aluminum porous body is used in a positive electrode of a lithium battery, lithium cobaltate (LiCoO₂), lithium manganate (LiMn₂O₄), lithium nickel oxide (LiNiO₂), or the like is used as an active material. The active material is used in combination with a conductive additive and a binder. In an existing positive electrode material for lithium batteries, an active material is applied by coating onto the surface of an aluminum foil, which is used as an electrode. Although lithium batteries have a high capacity compared with nickel metal hydride batteries or capacitors, a further increase in capacity is desired in automotive use and the like. In order to improve the battery capacity per unit area, the coating thickness of the active material is increased. Furthermore, in order to effectively use the active material, it is necessary that the aluminum foil constituting the current collector and the active material be electrically in contact with each other. Accordingly, the active material is mixed with the conductive additive for use. In contrast, the aluminum porous body of the present invention has a high porosity and a large surface area per unit area. Therefore, since the contact area between the current collector and the active material increases, the active material can be effectively used, and the battery capacity can be improved. Furthermore, the amount of the conductive additive to be mixed can be decreased. In a lithium battery, the positive electrode material described above is used for the positive electrode. As for a negative electrode, a foil, punched metal, porous body, or the like of copper or nickel is used as a current collector, and graphite, lithium titanate (Li₄Ti₅O₁₂), an alloy system including Sn, Si, or the like, lithium metal, or the like, is used as a negative electrode active material. The negative electrode active material is also mixed with a conductive additive and a binder for use.

In such a lithium battery, the capacity can be improved even with a small electrode area, and thus it is possible to increase the energy density of the battery compared with an existing lithium ion secondary battery including an aluminum foil. Furthermore, although the advantageous effects mainly about secondary batteries have been described, the advantageous effect in that the contact area is increased when an active material is filled into aluminum porous bodies in secondary batteries can also be obtained in primary batteries, and it is possible to improve the capacity.

### (Structure of Lithium Battery)

A nonaqueous electrolytic solution or a solid electrolyte is used as an electrolyte in a lithium battery. FIG. 3 is a longitudinal cross-sectional view of an all-solid-state lithium battery using a solid electrolyte. An all-solid-state lithium battery 60 includes a positive electrode 61, a negative electrode 62, and a solid electrolyte layer (SE layer) 63 disposed between the two electrodes. The positive electrode 61 includes a positive electrode layer (positive electrode body) 64 and a positive electrode current collector 65, and the negative electrode 62 includes a negative electrode layer 66 and a negative electrode current collector 67. As the electrolyte, besides the solid electrolyte, a nonaqueous electrolytic solution, which will be described below, may be used. In such a case, a separator (porous polymer film, nonwoven fabric, paper, or the like) is disposed between the two electrodes, and the nonaqueous electrolytic solution is impregnated into the two electrodes and the separator.

(Active Material to be Filled into Aluminum Porous Body)

When an aluminum porous body is used for a positive electrode of a lithium battery, a material into or from which lithium can be inserted or removed can be used as an active material. By filling such a material into the aluminum porous body, an electrode suitable for a lithium battery can be obtained. Examples of the positive electrode active material that can be used include lithium cobaltate (LiCoO₂), lithium nickel oxide (LiNiO₂), lithium cobalt nickel oxide (LiCo_{0.3}Ni_{0.7}O₂), lithium manganate (LiMn₂O₄), lithium titanate (Li₄Ti₅O₁₂), lithium manganese oxide compounds (LiM_{y}Mn_{2-y}O₄; M=Cr, Co, Ni), lithium-containing oxides, and the like. The active material is used in combination with a conductive additive and a binder. Examples also include transition metal oxides, such as olivine-type compounds, e.g., known lithium iron phosphate and compounds thereof (LiFePO₄, LiFe_{0.5}Mn_{0.5}PO₄). Furthermore, a portion of a transition metal element included in these materials may be replaced with another transition metal element.

Other examples of the positive electrode active material include lithium metal having, as a skeleton, a sulfide chalcogenide, such as TiS₂, V₂S₃, FeS, FeS₂, or LiMSx (M is a transition metal element, such as Mo, Ti, Cu, Ni, or Fe, or Sb, Sn, or Pb) or a metal oxide, such as TiO₂, Cr₃O₈, V₂O₅, or MnO₂. The lithium titanate (Li₄Ti₅O₁₂) described above can also be used as a negative electrode active material.

### (Electrolytic Solution Used in Lithium Battery)

A nonaqueous electrolytic solution is used in a polar aprotic organic solvent, and specifically, ethylene carbonate, diethyl carbonate, dimethyl carbonate, propylene carbonate, γ-butyrolactone, sulfolane, or the like is used. As a supporting salt, lithium tetrafluoroborate, lithium hexafluorophosphate, an imide salt, or the like is used. The concentration of the supporting salt which serves as an electrolyte is desirably as high as possible. However, since there is a limit to dissolution, the concentration of the supporting salt is generally set at about 1 mol/L.

(Solid Electrolyte to be Filled into Aluminum Porous Body)

A solid electrolyte, in addition to an active material, may be filled into an aluminum porous body. By filling the aluminum porous body with the active material and the solid electrolyte, an electrode suitable for an all-solid-state lithium ion secondary battery can be obtained. However, from the standpoint of securing discharge capacity, the percentage of the active material in the total amount of materials to be filled into the aluminum porous body is preferably 50% by mass or more, and more preferably 70% by mass or more.

As the solid electrolyte, a sulfide solid electrolyte having high lithium ion conductivity is preferably used. As such a sulfide solid electrolyte, for example, a sulfide solid electrolyte containing lithium, phosphorus, and sulfur may be used. The sulfide solid electrolyte may further contain an element, such as O, Al, B, Si, Ge, or the like.

The sulfide solid electrolyte can be obtained by a known method. For example, lithium sulfide (Li₂S) and phosphorus pentasulfide (P₂S₅) are prepared as starting materials, Li₂S and P₂S₅ are mixed at a molar ratio of about 50:50 to 80:20, and the mixture is melted and rapidly cooled (melt extraction method) or the mixture is subjected to mechanical milling (mechanical milling method).

The sulfide solid electrolyte obtained by the method described above is amorphous. The amorphous sulfide solid electrolyte may be used as it is or may be heated to form a crystalline sulfide solid electrolyte. By crystallization, the lithium ion conductivity can be expected to improve.

(Filling of Active Material into Aluminum Porous Body)

Filling of the active material (or the active material and the solid electrolyte) may be performed by a known method, such as an immersion filling method or a coating method. Examples of the coating method include roll coating, applicator coating, electrostatic coating, powder coating, spray coating, spray coater coating, bar coater coating, roll coater coating, dip coater coating, doctor blade coating, wire-bar coating, knife coater coating, blade coating, and screen coating.

When filling of the active material (or the active material and the solid electrolyte) is performed, for example, as necessary, a conductive additive and a binder are added to the active material, and an organic solvent or water is mixed thereinto to prepare a positive electrode mixture slurry. The slurry is filled into the aluminum porous body using the method described above. As the conductive additive, for example, carbon black, such as acetylene black (AB) or Ketjenblack (KB), or carbon fibers, such as carbon nanotubes (CNTs), can be used. As the binder, for example, polyvinylidene fluoride (PVDF), polytetrafluoroethylene (PTFE), polyvinyl alcohol (PVA), carboxymethylcellulose (CMC), xanthan gum, or the like can be used.

As the organic solvent used for preparing the positive electrode mixture slurry, any organic solvent can be appropriately selected as long as it does not adversely affect the materials (i.e., the active material, conductive additive, binder, and as necessary, solid electrolyte) to be filled into the aluminum porous body. Examples of such an organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, and N-methyl-2-pyrrolidone. Furthermore, in the case where water is used as a solvent, a surfactant may be used in order to enhance a filling property.

In an existing positive electrode material for lithium batteries, an active material is applied by coating onto the surface of an aluminum foil. In order to improve the battery capacity per unit area, the coating thickness of the active material is increased. Furthermore, in order to effectively use the active material, it is necessary that the aluminum foil and the active material be electrically in contact with each other. Accordingly, the active material is mixed with the conductive additive for use. In contrast, the aluminum porous body of the present invention has a high porosity and a large surface area per unit area. Therefore, since the contact area between the current collector and the active material increases, the active material can be effectively used, the battery capacity can be improved, and the amount of conductive additive to be mixed can be decreased.

### (Electrode for Capacitor)

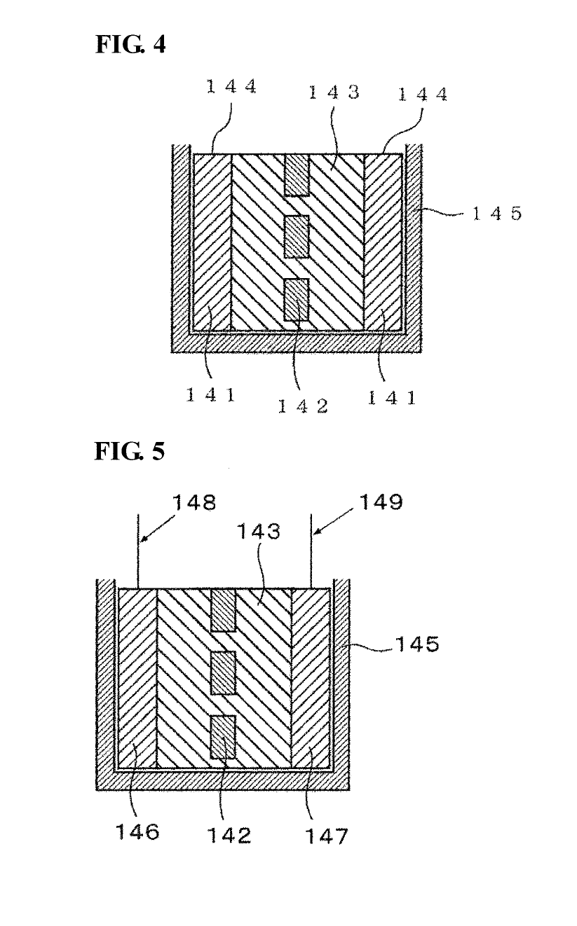

FIG. 4 is a cross-sectional schematic view showing an example of a capacitor in which an electrode material for a capacitor is used. Electrode materials serving as polarizable electrodes 141, in each of which an electrode active material is carried on an aluminum porous body, are placed in an organic electrolytic solution 143 separated by a separator 142. The polarizable electrodes 141 are connected to leads 144, and all of these members are housed in a case 145. By using aluminum porous bodies as current collectors, the surface area of the current collectors increases, and the contact area with activated carbon serving as the active material is increased. Therefore, it is possible to obtain a capacitor capable of increasing output and capacity.

In order to produce an electrode for a capacitor, activated carbon serving as an active material is filled into an aluminum porous body current collector. The activated carbon is used in combination with a conductive additive and a binder. A larger amount of activated carbon, which is a main component, is desirable in order to increase the capacity of the capacitor, and preferably the amount of activated carbon is 90% by mass or more in terms of composition ratio after drying (after removal of solvent). Furthermore, although necessary, the conductive additive and the binder are factors in the decrease of the capacity, and furthermore, the binder is a factor in the increase of the internal resistance. Therefore, it is desirable to decrease the amounts of the conductive additive and the binder as much as possible. The amount of the conductive additive is preferably 10% by mass or less, and the amount of the binder is preferably 10% by mass or less.

As the surface area of activated carbon is increased, the capacity of the capacitor is increased. Therefore, the specific surface area is preferably 1,000 m²/g or more. As the activated carbon, a plant-based material, such as coconut shell, or a petroleum-based material may be used. In order to improve the surface area of activated carbon, preferably, activation treatment is performed using water vapor or an alkali.

By mixing and stirring the electrode material including the activated carbon as a main component, a positive electrode mixture slurry is obtained. The positive electrode mixture slurry is filled into the current collector, followed by drying, and as necessary, the density is increased by compression with a roller press or the like. Thereby, an electrode for a capacitor is obtained.

(Filling of Activated Carbon into Aluminum Porous Body)

Filling of activated carbon may be performed by a known method, such as an immersion filling method or a coating method. Examples of the coating method include roll coating, applicator coating, electrostatic coating, powder coating, spray coating, spray coater coating, bar coater coating, roll coater coating, dip coater coating, doctor blade coating, wire-bar coating, knife coater coating, blade coating, and screen coating.

When filling of activated carbon is performed, for example, as necessary, a conductive additive and a binder are added to the activated carbon, and an organic solvent or water is mixed thereinto to prepare a positive electrode mixture slurry. The slurry is filled into the aluminum porous body using the method described above. As the conductive additive, for example, carbon black, such as acetylene black (AB) or Ketjenblack (KB), or carbon fibers, such as carbon nanotubes (CNTs), can be used. As the binder, for example, polyvinylidene fluoride (PVDF), polytetrafluoroethylene (PTFE), polyvinyl alcohol (PVA), carboxymethylcellulose (CMC), xanthan gum, or the like can be used.

As the organic solvent used for preparing the positive electrode mixture slurry, any organic solvent can be appropriately selected as long as it does not adversely affect the materials (i.e., the active material, conductive additive, binder, and as necessary, solid electrolyte) to be filled into the aluminum porous body. Examples of such an organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, and N-methyl-2-pyrrolidone. Furthermore, in the case where water is used as a solvent, a surfactant may be used in order to enhance a filling property.

### (Fabrication of Capacitor)

Two electrodes are prepared by cutting out electrodes obtained as described above to an appropriate size, and are placed to face each other with a separator therebetween. As the separator, a porous membrane or nonwoven fabric composed of cellulose, a polyolefin resin, or the like is preferably used. Using necessary spacers, the structure is housed in a cell case, and an electrolytic solution is impregnated thereinto. Finally, the case is sealed by placing a lid thereon with an insulating gasket therebetween. Thereby, an electric double layer capacitor is fabricated. In the case where a nonaqueous material is used, in order to minimize moisture in the capacitor, preferably, components such as electrodes are thoroughly dried. Fabrication of the capacitor may be performed in an environment with low moisture, and sealing may be performed under a reduced pressure environment. As long as current collectors and electrodes of the present invention are used, the capacitor is not particularly limited, and the capacitor may be fabricated by a method other than that described above.

The electrolytic solution to be used may be either aqueous or nonaqueous. A nonaqueous electrolytic solution is preferable because the voltage can be set to be high. In the case of an aqueous electrolytic solution, potassium hydroxide or the like can be used as an electrolyte. In the case of a nonaqueous electrolytic solution, many ionic liquids with different combinations of cations and anions are available. Examples of cations that can be used include lower aliphatic quaternary ammonium, lower aliphatic quaternary phosphonium, and imidazolinium. As examples of anions, metal chloride ions, metal fluoride ions, and imide compounds, such as bis(fluorosulfonyl)imide, are known. Furthermore, as a solvent for the electrolytic solution, a polar aprotic organic solvent is used, and specific examples thereof include ethylene carbonate, diethyl carbonate, dimethyl carbonate, propylene carbonate, γ-butyrolactone, and sulfolane. As a supporting salt in the nonaqueous electrolytic solution, lithium tetrafluoroborate, lithium hexafluorophosphate, or the like is used.

### (Lithium Ion Capacitor)

FIG. 5 is cross-sectional schematic view showing an example of a lithium ion capacitor in which an electrode material for a lithium ion capacitor is used. In an organic electrolytic solution 143 separated by a separator 142, an electrode material in which a positive electrode active material is carried on an aluminum porous body is placed as a positive electrode 146 and an electrode material in which a negative electrode active material is carried on a current collector is placed as a negative electrode 147. The positive electrode 146 and the negative electrode 147 are connected to leads 148 and 149, respectively, and all of these members are housed in a case 145. By using an aluminum porous body as a current collector, the surface area of the current collector increases, and even if activated carbon serving as the active material is applied thinly, it is possible to obtain a lithium ion capacitor capable of increasing output and capacity.

### (Positive Electrode)

In order to produce an electrode for a lithium ion capacitor, activated carbon serving as an active material is filled into an aluminum porous body current collector. The activated carbon is used in combination with a conductive additive and a binder. A larger amount of activated carbon, which is a main component, is desirable in order to increase the capacity of the lithium ion capacitor, and preferably the amount of activated carbon is 90% by mass or more in terms of composition ratio after drying (after removal of solvent). Furthermore, although necessary, the conductive additive and the binder are factors in the decrease of the capacity, and furthermore, the binder is a factor in the increase of the internal resistance. Therefore, it is desirable to decrease the amounts of the conductive additive and the binder as much as possible. The amount of the conductive additive is preferably 10% by mass or less, and the amount of the binder is preferably 10% by mass or less.

As the surface area of activated carbon is increased, the capacity of the lithium ion capacitor is increased. Therefore, the specific surface area is preferably 1,000 m²/g or more. As the activated carbon, a plant-based material, such as coconut shell, or a petroleum-based material may be used. In order to improve the surface area of activated carbon, preferably, activation treatment is performed using water vapor or an alkali.

By mixing and stirring the electrode material including the activated carbon as a main component, a positive electrode mixture slurry is obtained. The positive electrode mixture slurry is filled into the current collector, followed by drying, and as necessary, the density is increased by compression with a roller press or the like. Thereby, an electrode for a capacitor is obtained.

(Filling of Activated Carbon into Aluminum Porous Body)

Filling of activated carbon may be performed by a known method, such as an immersion filling method or a coating method. Examples of the coating method include roll coating, applicator coating, electrostatic coating, powder coating, spray coating, spray coater coating, bar coater coating, roll coater coating, dip coater coating, doctor blade coating, wire-bar coating, knife coater coating, blade coating, and screen coating.

When filling of activated carbon is performed, for example, as necessary, a conductive additive and a binder are added to the activated carbon, and an organic solvent or water is mixed thereinto to prepare a positive electrode mixture slurry. The slurry is filled into the aluminum porous body using the method described above. As the conductive additive, for example, carbon black, such as acetylene black (AB) or Ketjenblack (KB), or carbon fibers, such as carbon nanotubes (CNTs), can be used. As the binder, for example, polyvinylidene fluoride (PVDF), polytetrafluoroethylene (PTFE), polyvinyl alcohol (PVA), carboxymethylcellulose (CMC), xanthan gum, or the like can be used.

As the organic solvent used for preparing the positive electrode mixture slurry, any organic solvent can be appropriately selected as long as it does not adversely affect the materials (i.e., the active material, conductive additive, binder, and as necessary, solid electrolyte) to be filled into the aluminum porous body. Examples of such an organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, and N-methyl-2-pyrrolidone. Furthermore, in the case where water is used as a solvent, a surfactant may be used in order to enhance a filling property.

### (Negative Electrode)

The negative electrode is not particularly limited, and an existing negative electrode for a lithium battery may be used. However, since an existing negative electrode in which a copper foil is used as a current collector has a small capacity, an electrode in which an active material is filled into a porous body of copper or nickel, such as the foamed nickel described above, is preferably used. Furthermore, in order to make the device to operate as a lithium ion capacitor, preferably, the negative electrode is doped with lithium ions in advance. As a doping method, a known method can be used. Examples thereof include a method in which a lithium metal foil is attached to the surface of a negative electrode, and the negative electrode provided with the lithium metal foil is immersed in an electrolytic solution to perform doping, a method in which an electrode provided with lithium metal is placed in a lithium ion capacitor, a cell is assembled, and then a current is applied between a negative electrode and the lithium metal electrode to perform doping electrically, and a method in which an electrochemical cell is assembled using a negative electrode and lithium metal, and the negative electrode electrically doped with lithium is taken out and used.

In any of the methods described above, it is desirable to increase the doping amount of lithium in order to sufficiently decrease the potential of the negative electrode. However, when the residual capacity of the negative electrode becomes smaller than the positive electrode capacity, the capacity of the lithium ion capacitor decreases. Therefore, it is preferable to leave a portion corresponding to the positive electrode capacity without being doped.

### (Electrolytic Solution Used in Lithium Ion Capacitor)

As an electrolytic solution, the same nonaqueous electrolytic solution as that used in the lithium battery is used. The nonaqueous electrolytic solution is used in a polar aprotic organic solvent, and specifically, ethylene carbonate, diethyl carbonate, dimethyl carbonate, propylene carbonate, γ-butyrolactone, sulfolane, or the like is used. As a supporting salt, lithium tetrafluoroborate, lithium hexafluorophosphate, an imide salt, or the like is used.

### (Fabrication of Lithium Ion Capacitor)

An electrode obtained as described above is cut out to an appropriate size and is placed so as to face a negative electrode with a separator therebetween. As the negative electrode, an electrode which has been doped with lithium ions by the method described above may be used. Alternatively, in the case where a method is employed in which doping is performed after the cell is assembled, an electrode connected with lithium metal may be placed in the cell. As the separator, a porous membrane or nonwoven fabric composed of cellulose, a polyolefin resin, or the like is preferably used. Using necessary spacers, the structure is housed in a cell case, and the electrolytic solution is impregnated thereinto. Finally, the case is sealed by placing a lid on the case with an insulating gasket therebetween. Thereby, a lithium ion capacitor is fabricated. In order to minimize moisture in the lithium ion capacitor, preferably, materials such as electrodes are thoroughly dried. Fabrication of the lithium ion capacitor may be performed in an environment with low moisture, and sealing may be performed under a reduced pressure environment. As long as a current collector and an electrode of the present invention are used, the lithium ion capacitor is not particularly limited, and the lithium ion capacitor may be fabricated by a method other than that described above.

### (Electrode for Molten Salt Battery)

An aluminum porous body can also be used as an electrode material for a molten salt battery. In the case where an aluminum porous body is used as a positive electrode material, a metal compound, such as sodium chromate (NaCrO₂) or titanium disulfide (TiS₂), into which cations of the molten salt serving as an electrolyte can be intercalated, is used as an active material. The active material is used in combination with a conductive additive and a binder. As the conductive additive, acetylene black or the like can be used. As the binder, polytetrafluoroethylene (PTFE) or the like can be used. In the case where sodium chromate is used as the active material and acetylene black is used as the conductive additive, PTFE can strongly bind both materials, which is preferable.

An aluminum porous body can also be used as a negative electrode material for a molten salt battery. In the case where an aluminum porous body is used as a negative electrode material, elemental sodium, an alloy of sodium and another metal, carbon, or the like can be used as an active material. The melting point of sodium is about 98° C., and as the temperature increases, metal becomes soft. Therefore, it is preferable to alloy sodium with another metal (Si, Sn, In, or the like). Among these, in particular, an alloy of sodium and Sn is easy to handle, thus being preferable. Sodium or a sodium alloy can be carried on the surface of the aluminum porous body by electrolytic plating, hot dip coating, or the like. Another method may be used in which, after a metal (Si or the like) to be alloyed with sodium is attached to the aluminum porous body by plating or the like, charging is performed in a molten salt battery to form a sodium alloy.

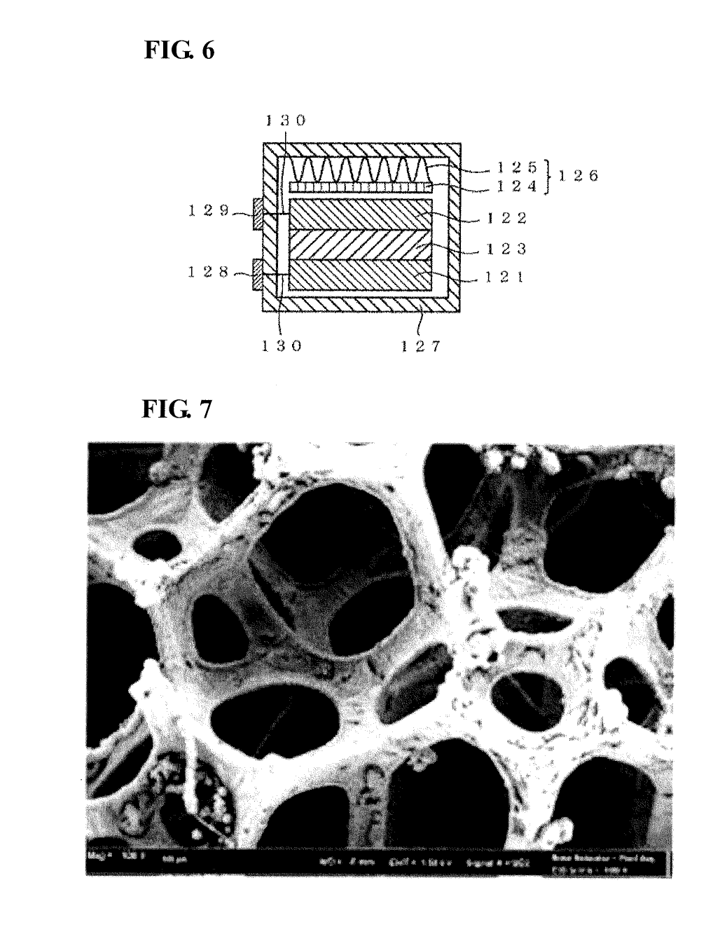

FIG. 6 is a cross-sectional schematic view showing an example of a molten salt battery in which the electrode materials for a battery are used. In the molten salt battery, a positive electrode 121 in which a positive electrode active material is carried on the surface of an aluminum skeleton of an aluminum porous body, a negative electrode 122 in which a negative electrode active material is carried on the surface of an aluminum skeleton of an aluminum porous body, and a separator 123 impregnated with a molten salt serving as an electrolyte are housed in a case 127. A pressing member 126 which includes a pressure plate 124 and a spring 125 that presses the pressure plate 124 is disposed between the upper surface of the case 127 and the negative electrode. By providing the pressing member 126, even when volume changes occur in the positive electrode 121, the negative electrode 122, and the separator 123, pressing is performed uniformly so that contact between the individual members can be achieved. The current collector (aluminum porous body) of the positive electrode 121 and the current collector (aluminum porous body) of the negative electrode 122 are respectively connected to a positive electrode terminal 128 and a negative electrode terminal 129 by leads 130.

As the molten salt serving as an electrolyte, any of various inorganic salts and organic salts that melt at the operating temperature can be used. As the cation of the molten salt, at least one selected from the group consisting of alkali metals, such as lithium (Li), sodium (Na), potassium (K), rubidium (Rb), and cesium (Cs), and alkaline-earth metals, such as beryllium (Be), magnesium (Mg), calcium (Ca), strontium (Sr), and barium (Ba), can be used.

In order to decrease the melting point of the molten salt, preferably, two or more salts are mixed for use. For example, when potassium bis(fluorosulfonyl)amide [K—N(SO₂F)₂; KFSA] and sodium bis(fluorosulfonyl)amide [Na—N(SO₂F)₂; NaFSA] are combined for use, the operating temperature of the battery can be set at 90° C. or lower.

The molten salt is used by being impregnated into the separator. The separator prevents the positive electrode and the negative electrode from being brought into contact with each other, and a glass nonwoven fabric, a porous resin, or the like can be used as the separator. The positive electrode, the separator impregnated with the molten salt, and the negative electrode are stacked and housed in the case, and then used as a battery.

### EXAMPLES

The present invention will be described in more details with reference to examples. It is to be understood that the present invention is not limited to the examples.

### (Formation of Conductive Layer)

A production example of an aluminum porous body will be specifically described below. A polyurethane foam with a thickness of 1 mm, a porosity of 95%, and a number of pores (cells) per inch of about 50 was prepared as a foamed resin molded body, and cut into a square of 100 mm×30 mm. The polyurethane foam was immersed in a carbon suspension, followed by drying. Thereby, a conductive layer, to the entire surface of which carbon particles were attached, was formed. The suspension contained 25% by mass of graphite and carbon black, and also contained a resin binder, a penetrating agent, and an anti-foaming agent. The particle size of the carbon black was 0.5 μm.

### (Molten Salt Plating)

The polyurethane foam having the conductive layer on the surface thereof, as a workpiece, was fixed on a jig having a power feeding function. Then, the jig on which the workpiece was fixed was placed in a glove box set in an argon atmosphere and at a low moisture (dew point −30° C. or lower), and immersed in a molten salt aluminum plating bath (33 mol % EMIC-67 mol % AlCl₃) at a temperature of 40° C. The jig on which the workpiece was fixed was connected to the negative side of a rectifier, and an aluminum plate (purity 99.99%) as a counter electrode was connected to the positive side. Plating was performed by applying a DC current with a current density of 3.6 A/dm² for 90 minutes. Thereby, an aluminum structure in which an aluminum plating layer with a weight of 150 g/m² was formed on the surface of the polyurethane foam was obtained. Stirring was performed with a stirrer using a rotor made of Teflon (registered trademark). The current density is a value calculated using the apparent area of the polyurethane foam.

A sample was taken from the skeleton portion of the resulting aluminum porous body, and a cross section perpendicular to the direction in which the skeleton extended was observed. The cross section had a substantially triangular shape, reflecting the structure of the polyurethane foam used as the core.

### (Decomposition of Foamed Resin Molded Body)

The aluminum structure was immersed in a LiCl—KCl eutectic molten salt at 500° C., and a negative potential of −1 V was applied thereto for 30 minutes. Bubbles were generated resulting from the decomposition of polyurethane in the molten salt. After cooling to room temperature in air, the aluminum structure was cleaned with water to remove the molten salt. Thereby, the aluminum porous body from which the resin had been removed was obtained. FIG. 7 is an enlarged photograph showing the resulting aluminum porous body. The aluminum porous body had interconnecting pores and a high porosity as in the polyurethane foam used as the core.

The resulting aluminum porous body was dissolved in aqua regia. When measured with an inductively coupled plasma (ICP) emission spectrometer, the aluminum purity was 98.5% by mass. When measured by an infrared absorption method after combustion in a high-frequency induction heating furnace according to JIS-G1211, the carbon content was 1.4% by mass. Furthermore, when the surface was subjected to EDX analysis at an accelerating voltage of 15 kV, substantially no peaks of oxygen were observed, and thus it was confirmed that the oxygen content in the aluminum porous body was equal to or less than the detection limit (3.1% by mass) of EDX.

### (Fabrication of Lithium Secondary Battery 1)

An aluminum porous body was produced using, as a substrate, a polyurethane foam with a thickness of 1 mm and an average cell diameter of 450 μm, and cut into a square of 10 cm×10 cm. The aluminum porous body had a rectangular shape in plan view. An aluminum tab lead with a width of 20 mm was spot-welded to an end of the aluminum porous body. Lithium cobaltate was used as a positive electrode active material. A mixture was prepared at the composition ratio LiCoO₂:acetylene black:PVDF=88:6:6, and was formed into a slurry using an N-methyl-2-pyrrolidone solvent (NMP). The slurry was filled into the aluminum porous body, followed by drying and pressing. Thereby, an electrode was produced. The resulting electrode had a thickness of 0.5 mm and a filling capacity of 8 mAh/cm². Lithium titanate was used as a negative electrode active material. A mixture was prepared at the composition ratio Li₄Ti₅O₁₂:acetylene black:PVDF=88:6:6, and was formed into a slurry using an NMP solvent. The slurry was filled into an aluminum porous body, followed by drying and pressing. Thereby, an electrode was produced. The resulting electrode had a thickness of 0.4 mm and a filling capacity of 9.2 mAh/cm². Three positive electrodes (described above) and three negative electrodes (described above) were alternately stacked with a polyethylene nonwoven fabric separator with a thickness of 30 μm interposed therebetween, and aluminum tab leads of the positive electrodes and aluminum tab leads of the negative electrodes were spot-welded to obtain an electrode group.

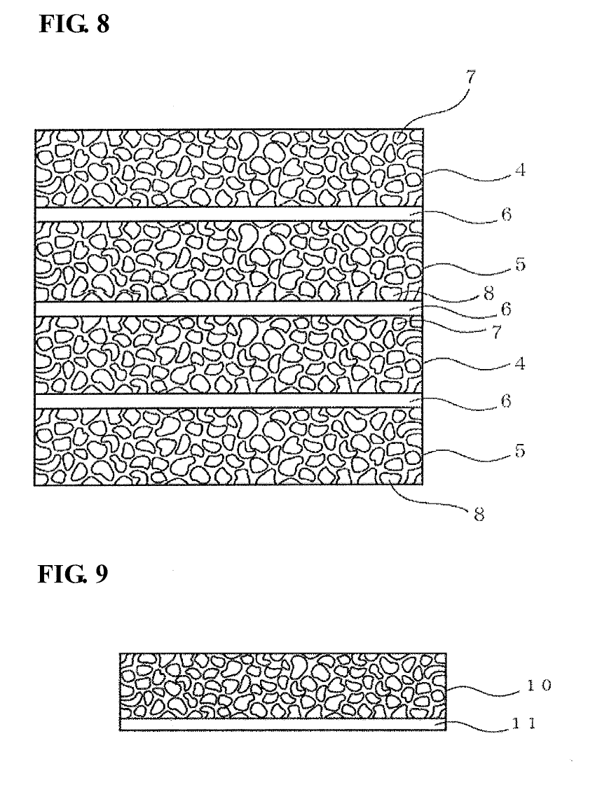

FIG. 8 illustrates a stacking state of electrodes. In FIG. 8, positive electrodes 4, each including an aluminum porous body filled with an active material 7, and negative electrodes 5, each including an aluminum porous body filled with an active material 8, are stacked with a separator 6 interposed therebetween.

The positive and negative terminals of the electrode group were spot-welded to extracting tab leads. The resulting structure was enveloped by an aluminum laminate film, and fusion bonding was performed by heat-sealing with one side being left open. This was dried under a reduced pressure of 1 kPa or less at a temperature of 80° C. to 180° C. for 10 hours. As an electrolytic solution, a mixed solution of lithium hexafluorophosphate (LiPF₆)/ethylene carbonate (EC)-diethyl carbonate (DEC) with a concentration of 1 mol/L in the amount of 80 cc was poured thereinto, and aluminum laminate sealing was performed with a vacuum packing apparatus. Thereby, a rectangular stacked battery with a capacity of 2,400 mAh was obtained. The final size of the battery was 120 mm×110 mm×3.4 mm (in thickness), excluding protruding portions of the tabs.

In the case where a similar battery is produced using an aluminum foil electrode, since the capacity density of the aluminum foil electrode for both surfaces is generally 2 to 6 mAh/cm², the electrode capacity for a size of 10 cm×10 cm is at most 0.75 times that of the present invention. The amount of aluminum foil electrodes used is 1.3 times that of the present invention. Consequently, in accordance with the structure of the present invention, it is possible to decrease the number of processing operations, and as the battery capacity increases, the difference becomes noticeable. For example, regarding batteries for electric cars which have been receiving attention, batteries with a capacity of about 60 Ah have started being mounted. In such a case, when aluminum foils are used, it is necessary to process as much as 10,000 cm² of electrodes. In contrast, when electrodes of the present invention are used, the amount of electrodes used is ¾ times that of the aluminum foils.

### (Fabrication of Lithium Secondary Battery 2)

An aluminum porous body was produced using, as a substrate, a polyurethane foam with a thickness of 1 mm and an average cell diameter of 450 μm. Lithium cobaltate was used as a positive electrode active material. A mixture was prepared at the composition ratio LiCoO₂:acetylene black:PVDF=88:6:6, and was formed into a slurry using an NMP solvent. The slurry was filled into the aluminum porous body, followed by drying and pressing. Thereby, an electrode was produced. The resulting electrode had a thickness of 0.4 mm and a filling capacity of 10 mAh/cm². Lithium titanate was used as a negative electrode active material. A mixture was prepared at the composition ratio Li₄Ti₅O₁₂:acetylene black:PVDF=88:6:6, and was formed into a slurry using an NMP solvent. The slurry was filled into an aluminum porous body, followed by drying and pressing. Thereby, an electrode was produced. The resulting electrode had a thickness of 0.4 mm and a filling capacity of 11 mAh/cm². Each of the electrodes was cut into a size of 60 mm in width and 400 mm in length. The aluminum porous body had a rectangular shape in plan view. The active material at one end of the positive electrode was removed by ultrasonic vibration, and an aluminum tab lead was welded to the removed portion. A polyethylene nonwoven fabric separator with a thickness of 30 μm was cut into a size of 64 mm in width and 840 mm in length, and folded in half to a length of 420 mm. The positive electrode was placed inside thereof. The negative electrode was further overlaid thereon, and winding was performed such that the negative electrode was located outside to thereby obtain a cylindrical electrode group. At this stage, the negative electrode is exposed at the outermost peripheral surface. The electrode group was inserted into a cylindrical aluminum can for 18650 battery, and the tab lead of the positive electrode was welded to a circular lid serving as a positive electrode. This was dried under a reduced pressure of 1 kPa or less at a temperature of 80° C. to 180° C. for 10 hours. As an electrolytic solution, a LiPF₆/EC-DEC solution with a concentration of 1 mol/L in the amount of 80 cc was poured thereinto, and the positive electrode lid was swaged. Thereby, a 18650 battery with a capacity of 2,400 mAh was obtained.

In the case where a similar battery is produced using an aluminum foil electrode, since the capacity density of the aluminum foil electrode for both surfaces is generally 2 to 6 mAh/cm², the amount of aluminum foil electrodes used is 1.7 times that of the present invention. Consequently, in accordance with the structure of the present invention, it is possible to decrease the number of processing operations.

### (Fabrication of Lithium Secondary Battery 3)

An aluminum porous body was produced using, as a substrate, a polyurethane foam with a thickness of 1 mm and an average cell diameter of 450 μm, and cut into a square of 10 cm×10 cm. The aluminum porous body had a rectangular shape in plan view. An aluminum tab lead with a width of 20 mm was spot-welded to an end of the aluminum porous body. Lithium cobaltate was used as a positive electrode active material. A mixture was prepared at the composition ratio LiCoO₂:acetylene black:PVDF=88:6:6, and was formed into a slurry using an NMP solvent. The slurry was filled into the aluminum porous body, followed by drying and pressing. Thereby, an electrode was produced. The resulting electrode had a thickness of 0.5 mm and a filling capacity of 8 mAh/cm². Lithium titanate was used as a negative electrode active material. A mixture was prepared at the composition ratio Li₄Ti₅O₁₂:acetylene black:PVDF=88:6:6, and was formed into a slurry using an NMP solvent. The slurry was filled into the aluminum porous body, followed by drying and pressing. Thereby, an electrode was produced. The resulting electrode had a thickness of 0.4 mm and a filling capacity of 9.2 mAh/cm². The positive electrode was enclosed by a polyethylene nonwoven fabric separator with a thickness of 30 μm, and three sides thereof were heat-sealed. Three positive electrodes (described above) and three negative electrodes (described above) were alternately stacked, and aluminum tab leads of the positive electrodes and aluminum tab leads of the negative electrodes were spot-welded to obtain an electrode group. The positive and negative terminals of the electrode group were spot-welded to extracting tab leads. The resulting structure was enveloped by an aluminum laminate film, and fusion bonding was performed by heat-sealing with one side being left open. This was dried under a reduced pressure of 1 kPa or less at a temperature of 80° C. to 180° C. for 10 hours. As an electrolytic solution, a LiPF₆/EC-DEC solution with a concentration of 1 mol/L in the amount of 80 cc was poured thereinto, and aluminum laminate sealing was performed with a vacuum packing apparatus. Thereby, a rectangular stacked battery with a capacity of 2,400 mAh was obtained. The final size of the battery was 120 mm×110 mm×3.4 mm (in thickness), excluding protruding portions of the tabs.

In a cylindrical 18650 battery of 2,400 mAh, when a failure occurs, the entire cell needs to be replaced, and all of the electrodes (in total about 800 cm² for positive and negative electrodes) are discarded. In contrast, by employing the stack-type structure of the present invention, defective electrodes need only be removed, and thus the minimum amount discarded will be 100 cm².

Furthermore, in the embodiment described above, the case that houses electrodes may be a metal case having good heat dissipation, and furthermore, by providing irregularities on the metal case, heat dissipation may be improved. In the case where a resin case is used, heat dissipation may be improved by attaching a metal foil thereto, and furthermore, irregularities may be provided on the metal foil. Moreover, in a battery that is mounted in a car or the like, it is also preferable to cool the battery using a water-cooling mechanism installed in the car or the like. In particular, since a large current flows in a tab lead portion, it is preferable to design so as to improve heat dissipation in the tab lead portion and its vicinity. A cooling design that is difficult in the battery having the wound structure can be used in the stack-type structure, and thus larger freedom in design is permitted.

### (Stacked Structure Including Aluminum Porous Body and Aluminum Foil)

In a representative example of an aluminum structure including an aluminum foil and a three-dimensional structure composed of aluminum disposed on the surface of the aluminum foil, after an aluminum porous body is formed by the method described above, an aluminum foil is attached to one plane of the aluminum porous body by ultrasonic welding. FIG. 9 shows a structure of a current collector. In FIG. 9, an aluminum porous body 10 is integrally stacked on an aluminum foil 11. In a lithium ion secondary battery in which a stacked body including an aluminum porous body and an aluminum foil obtained by the method described above is used as a current collector of the battery, the volume energy density and output characteristics are high compared with an existing battery in which an aluminum foil only is used. Furthermore, since one surface of the aluminum porous body is the aluminum foil, it is easy to wind an electrode when a wound battery is produced.

Furthermore, by using a method in which electrostatic flocking is performed on one surface or both surfaces of an aluminum foil, molten salt aluminum plating is performed, and then flocked portions are thermally decomposed at a temperature of 400° C. or higher, it is possible to obtain another aluminum structure having a three-dimensional structure composed of an aluminum on the surfaces of the aluminum foil. Such a structure is not limited to aluminum, and in a nickel metal hydride battery, by using a nickel porous body in a positive electrode current collector, the volume energy density is improved, and an improvement in output characteristics (miniaturization of cell diameter) are also achieved.

The disclosure may include other embodiments described below.

In another embodiment 1, an electrode for an electrochemical device includes a metal structure including a metal foil and a three-dimensional structure composed of the same metal disposed on a surface of the metal foil, and an active material carried on the metal structure.

In another embodiment 2, an electrochemical device including an electrode for an electrochemical device which includes a metal structure including a metal foil and a three-dimensional structure composed of the same metal disposed on a surface of the metal foil, and an active material carried on the metal structure.

In another embodiment 3, a lithium ion secondary battery includes a positive electrode including an aluminum porous body having interconnecting pores and an active material filled into the pores of the aluminum porous body, a separator, and a negative electrode, the positive electrode, the separator, and the negative electrode being stacked, in which an electrode body including the positive electrode, the separator, and the negative electrode is wound.

In another embodiment 4, a capacitor includes an electrode including an aluminum porous body having interconnecting pores and an active material filled into the pores of the aluminum porous body, and a separator, the electrode and the separator being stacked, in which an electrode body including the electrode and the separator is wound.

In another embodiment 5, a lithium ion capacitor includes a positive electrode including an aluminum porous body having interconnecting pores and an active material filled into the pores of the aluminum porous body, a separator, and a negative electrode, the positive electrode, the separator, and the negative electrode being stacked, in which an electrode body including the positive electrode, the separator, and the negative electrode is wound.

### INDUSTRIAL APPLICABILITY

As described above, according to the present invention, since an electrode for a battery in which characteristics of an aluminum porous body are utilized can be obtained, the present invention can be widely applied to various electrodes, such as those in nonaqueous electrolyte batteries, such as lithium secondary batteries, molten salt batteries, capacitors, and lithium ion capacitors.

### REFERENCE SIGNS LIST

1 foamed resin molded body 2 conductive layer 3 aluminum plating layer 4 positive electrode 5 negative electrode 6 separator 7 active material 8 active material 10 aluminum porous body 11 aluminum foil 60 lithium battery 61 positive electrode 62 negative electrode 63 solid electrolyte layer (SE layer) 64 positive electrode layer (positive electrode body) 65 positive electrode current collector 66 negative electrode layer 67 negative electrode current collector 121 positive electrode 122 negative electrode 123 separator 124 pressure plate 125 spring 126 pressing member 127 case 128 positive electrode terminal 129 negative electrode terminal 130 lead 141 polarizable electrode 142 separator 143 organic electrolytic solution 144 lead 145 case 146 positive electrode 147 negative electrode 148 lead 149 lead

What is claimed is:

1. An electrochemical device comprising:
a first electrode including an aluminum porous body having interconnecting pores and an active material filled into the pores of the aluminum porous body;
a separator; and
a second electrode,
the first electrode, the separator, and the second electrode being stacked,
wherein a plurality of electrode bodies each including the first electrode, the separator, and the second electrode are stacked without being wound.

2. The electrochemical device according to claim 1, wherein the first electrode, the separator, and the second electrode each has a rectangular shape in plan view.

3. The electrochemical device according to claim 1, wherein the first electrode or the second electrode is configured so as to be enclosed by the separator.

4. The electrochemical device according to claim 1, wherein the first electrode is compressed in the thickness direction after the active material has been filled into the pores of the aluminum porous body having interconnecting pores.

5. An electrochemical device comprising:
a first electrode including an aluminum structure having an aluminum foil and a three-dimensional structure composed of aluminum disposed on a surface of the aluminum foil, and an active material filled into the three-dimensional structure of the aluminum structure;
a separator; and
a second electrode,
the first electrode, the separator, and the second electrode being stacked,
wherein a plurality of electrode bodies each including the first electrode, the separator, and the second electrode are stacked.

6. The electrochemical device according to claim 5, wherein the three-dimensional structure composed of aluminum is an aluminum porous body having interconnecting pores.

7. A lithium secondary battery comprising:
a negative electrode including an aluminum porous body having interconnecting pores and an active material filled into the pores of the aluminum porous body:
a separator; and
a positive electrode,
the negative electrode, the separator, and the positive electrode being stacked.

8. The lithium secondary battery according to claim 7, wherein the negative electrode does not contain carbon.

9. The electrochemical device according to claim 1, wherein the electrochemical device is a lithium secondary battery, the first electrode is a positive electrode, and the second electrode is a negative electrode.

10. The electrochemical device according to claim 9, wherein the negative electrode does not contain carbon.

11. The electrochemical device according to claim 1, wherein the electrochemical device is a capacitor.

12. The electrochemical device according to claim 1, wherein the electrochemical device is a lithium ion capacitor.
